(19) United States
(12) Patent Application Publication
(10) Pub. No.: US 2017/0353669 A1
(43) Pub. Date: Dec. 7, 2017

(54) TRACKING IMAGING CONTROL DEVICE, TRACKING IMAGING SYSTEM, CAMERA, TERMINAL DEVICE, TRACKING IMAGING METHOD, AND TRACKING IMAGING PROGRAM

(71) Applicant: FUJIFILM Corporation, Tokyo (JP)

(72) Inventor: Daisuke HAYASHI, Saitama-shi (JP)

(73) Assignee: FUJIFILM Corporation, Tokyo (JP)

(21) Appl. No.: 15/675,157

(22) Filed: Aug. 11, 2017

Related U.S. Application Data
(63) Continuation of application No. PCT/JP2015/083600, filed on Nov. 30, 2015.

(30) Foreign Application Priority Data
Feb. 18, 2015 (JP) 2015-029238

(51) Int. Cl. H04N 5/232; G06T 7/246; G06T 7/73; G06T 7/90; G06K 9/00

(52) U.S. Cl. CPC H04N 5/23296; G06T 7/73; G06T 7/90; H04N 5/23229; H04N 5/23219; G06T 7/246; G06K 9/00228; G06T 2207/20072; G06T 2207/20101; G06K 9/00342

(57) ABSTRACT

A tracking imaging control device includes a target color ratio calculation unit that calculates a ratio at which pixels with a certain range of hue occupy in the histogram as the target color ratio, with reference to the color of the target, and a tracking control unit that controls the pan and/or tilt operation of the camera to cause the camera to track the target, and the tracking control unit controls the pan and/or tilt operation of the camera on the basis of information on the position of the target detected by the first target detection unit when the target color ratio is equal to or lower than a threshold value, and controls the pan and/or tilt operation of the camera on the basis of information on the position of the target detected by the second target detection unit when the target color ratio exceeds the threshold value.

### CROSS-REFERENCE TO RELATED APPLICATIONS

The present application is a Continuation of PCT International Application No. PCT/JP2015/083600 filed on Nov. 30, 2015 claiming priority under 35 U.S.C §119(a) to Japanese Patent Application No. 2015-029238 filed on Feb. 18, 2015. Each of the above applications is hereby expressly incorporated by reference, in their entirety, into the present application.

### BACKGROUND OF THE INVENTION

### 1. Field of the Invention

The present invention relates to a tracking imaging control device, a tracking imaging system, a camera, a terminal device, a tracking imaging method, and a tracking imaging program in which a pan and/or tilt operation of a camera including a pan and/or tilt function is controlled and imaging is performed while automatically tracking a target.

### 2. Description of the Related Art

Generally, in tracking imaging, a position of a target is detected from an image captured by a camera, and a pan and/or tilt operation of the camera is controlled on the basis of information on the detected position of the target to track the target. In this tracking imaging, a method of using color information of a target is known as one method of detecting a position of a target from an image (for example, JP2001-169169A). In this method, the color information of the target is acquired in advance, a subject having the same color as the color of the target is detected from the image, and the position of the target is detected from the image.

However, in a method of detecting a position of a target from an image using information on the color of the target, there is a problem in that it is easy to erroneously detect the target if a larger number of colors similar to the target are included in a background.

In order to solve such a problem, a method of detecting a subject that is a candidate for a target from an image, detecting information on the subject, selecting an optimal method from among a plurality of methods of obtaining a position of the target on the basis of information on the detected subject, and detecting the position of the target has been proposed in

### SUMMARY OF THE INVENTION

However, the method of JP2012-85090A has a disadvantage that a load of a process is large since it is necessary to detect the information on the subject that is a sequential target candidate.

The present invention has been made in view of the above circumstances, and an object of the present invention is to provide a tracking imaging control device, a tracking imaging system, a camera, a terminal device, a tracking imaging method, and a tracking imaging program capable of simply detecting a position of a target and accurately tracking the target.

Means for solving the above problems are as follows.

[1] A tracking imaging control device that controls a pan and/or tilt operation of a camera including a pan function and/or a tilt function to cause the camera to execute imaging in which the target is tracked, the tracking imaging control device comprising: a target setting unit that sets the target; a hue histogram creation unit that creates a histogram of hue of a range in which the target is tracked; a target color information acquisition unit that acquires information on the color of the target; a first target detection unit that detects a position of the target from the image captured by the camera on the basis of the information on the color of the target; a second target detection unit that detects the position of the target from the image captured by the camera on the basis of information other than the color of the target; a target color ratio calculation unit that calculates a ratio at which pixels with a certain range of hue occupy in the histogram as the target color ratio, with reference to the color of the target; and a tracking control unit that controls the pan and/or tilt operation of the camera on the basis of information on the position of the target detected by the first target detection unit when the target color ratio is equal to or lower than a threshold value to cause the camera to track the target, and controls the pan and/or tilt operation of the camera on the basis of information on the position of the target detected by the second target detection unit when the target color ratio exceeds the threshold value to cause the camera to track the target.

According to this aspect, the first target detection unit and the second target detection unit are included as means for detecting the position of the target. The first target detection unit detects a position of the target from the image captured by the camera on the basis of information on the color of the target. The second target detection unit detects the position of the target from the image captured by the camera on the basis of information other than the color of the target. The first target detection unit and the second target detection unit are selectively used on the basis of a relationship between the color of the target and a color of a background. That is, in a case where the background includes a large number of colors of the target and approximate colors thereof, it is determined that it is difficult to detect the target on the basis of the color, and the target is tracked on the basis of a detection result of the second target detection unit. In other cases, it is determined that it is possible to detect the target on the basis of the color, and the target is tracked on the basis of the detection result of the first target detection unit. Whether or not the background includes a large number of colors of the target and approximate colors thereof is determined by creating the histogram of the hue in the range in which the target is tracked and calculating the target color ratio from the histogram. The target color ratio is calculated as a ratio at which the pixels with a certain range of hue occupy in the histogram with reference to the color of the target. In a case where the target color ratio exceeds the threshold value, it is determined that the background includes a large number of colors of the target and the approximate colors, and the target is tracked on the basis of the detection result of the second target detection unit. On the other hand, in a case where the target color ratio is equal to or lower than the threshold value, it is determined that the number of colors of the target and the approximate colors is small, and the target is tracked on the basis of the detection result of the first target detection unit. Thus, according to this aspect, the target color ratio is calculated, and results of the first target detection unit and the second target detection unit are selectively used on the basis of the calculated target color ratio. Accordingly, it is possible to simply detect the position of the target and accurately track the target.

[2] In the tracking imaging control device of [1], the second target detection unit detects the position of the target from the image captured by the camera on the basis of information on luminance or brightness of the target.

According to this aspect, the second target detection unit detects the position of the target from the image captured by the camera on the basis of information on luminance or brightness of the target. Accordingly, even in a case where a background includes a larger number of colors of the target and approximate colors, the position of the target can be detected from the image regardless of color information.

[3] In the tracking imaging control device of [1] or [2], the camera includes an imaging unit that captures an optical image of a subject through a lens, and a support unit that supports the imaging unit so that the imaging unit can be panned and/or tilted.

According to this aspect, the camera includes an imaging unit that captures an optical image of a subject through a lens, and a support unit that supports the imaging unit so that the imaging unit can be panned and/or tilted. In a case where the target is tracked, the target is tracked by panning and/or tilting the imaging unit and changing an imaging direction (a direction of the optical axis of the lens).

[4] In the tracking imaging control device of [1] or [2], the camera includes an imaging unit that captures an optical image of a subject through a fisheye lens; and an image cutout unit that cuts out a portion of the image captured by the imaging unit, and the pan and/or tilt function is realized by changing a position at which the image cutout unit cuts out an image.

According to this aspect, the camera includes the imaging unit that captures an optical image of a subject through a fisheye lens, and the image cutout unit that cuts out a portion of the image captured by the imaging unit. In a case where the target is tracked, the target is tracked by changing the position at which the image cutout unit cuts out an image.

[5] The tracking imaging control device of any one of [1] to [4] further comprises a tracking range setting unit that sets a range in which the target is tracked, as the tracking range.

According to this aspect, the tracking range setting unit is further included. The tracking range setting unit sets a range in which the target is tracked, as the tracking range. Accordingly, only a necessary area can be set as the tracking range, and the target can be efficiently detected. Further, it is possible to efficiently create the histogram.

[6] In the tracking imaging control device of [5], the tracking range setting unit sets the pan and/or tilt movable range of the camera as the tracking range.

According to this aspect, the tracking range setting unit sets the pan and/or tilt movable range of the camera as the tracking range. Accordingly, trouble of setting the tracking range can be reduced.

[7] The tracking imaging control device of [6] further comprises a movable range setting unit that sets a pan and/or tilt movable range of the camera.

According to this aspect, a movable range setting unit that sets a pan and/or tilt movable range of the camera is further comprised. Accordingly, if the pan and/or tilt movable range of the camera is set, the tracking range can be automatically set and trouble of setting the tracking range can be reduced. Further, pan and/or tilt can be performed only in a necessary area, and it is possible to efficiently track the target.

[8] In the tracking imaging control device of any one of [1] to [7], the hue histogram creation unit creates the histogram of the hue of the range in which the target is tracked, on the basis of image data obtained by imaging an entire range in which the target is tracked using the camera.

According to this aspect, the histogram of the hue of the range in which the target is tracked is created on the basis of image data obtained by imaging an entire range in which the target is tracked using the camera.

[9] The tracking imaging control device of any one of [1] to [8] further comprises a display unit that displays the image captured by the camera; and an input unit that designates a position on the screen of the display unit, and the target setting unit sets a subject at the position designated by the input unit as the target.

According to this aspect, the display unit that displays the image captured by the camera, and the input unit that designates a position on the screen of the display unit are further comprised, and a subject at the position designated by the input unit is set as the target. Accordingly, it is possible to simply set the target.

[10] The tracking imaging control device of any one of [1] to [8] further comprises a face detection unit that detects a face of a person from the image captured by the camera, and the target setting unit sets the face of the person detected by the face detection unit as the target.

According to this aspect, the face detection unit that detects a face of a person from the image captured by the camera is further comprised, and the face of the person detected by the face detection unit is set as the target. Accordingly, it is possible to simply set the target.

[11] The tracking imaging control device of any one of [1] to [8] further comprises a moving body detection unit that detects a moving body from the image captured by the camera, and the target setting unit sets the moving body first detected by the moving body detection unit as the target.

According to this aspect, the moving body detection unit that detects a moving body from the image captured by the camera is further comprised, and the moving body first detected by the moving body detection unit is set as the target. Accordingly, it is possible to simply set the target.

[12] In the tracking imaging control device of any one of [1] to [11], the hue histogram creation unit divides the range in which the target is tracked into a plurality of blocks, and creates the histogram of the hue for each of the blocks, the target color ratio calculation unit calculates a target color ratio for each block, the target color ratio being a ratio at which pixels with a certain range of hue occupy in the histogram with reference to the color of the target, and the tracking control unit controls the pan and/or tilt operation of the camera on the basis of the information on the position of the target detected by the first target detection unit for the block in which the target color ratio is equal to or lower than a threshold value to cause the camera to track the target, and controls the pan and/or tilt operation of the camera on the basis of the information on the position of the target detected by the second target detection unit for the block in which the target color ratio exceeds the threshold value to cause the camera to track the target.

According to this aspect, the range in which the target is tracked is divided into the plurality of blocks, and the target color ratio is calculated for each block. A result of means for detecting the position of the target is selectively used for each block. That is, the target is tracked on the basis of the information on the position of the target detected by the first target detection unit for the block in which the target color ratio is equal to or lower than a threshold value, and the target is tracked on the basis of the information on the position of the target detected by the second target detection unit for the block in which the target color ratio exceeds the threshold value. Thus, even in a case where the color of the background changes, the position of the target can be appropriately detected.

[13] A tracking imaging system that includes a camera including a pan function and/or a tilting function, and a terminal device that is communicatably connected to the camera and controls a pan and/or tilt operation of the camera to cause the camera to execute imaging in which the target is tracked, the terminal device comprising: a target setting unit that sets the target; a hue histogram creation unit that creates a histogram of hue of a range in which the target is tracked; a target color information acquisition unit that acquires information on the color of the target; a first target detection unit that detects a position of the target from the image captured by the camera on the basis of the information on the color of the target; a second target detection unit that detects the position of the target from the image captured by the camera on the basis of information other than the color of the target; a target color ratio calculation unit that calculates a ratio at which pixels with a certain range of hue occupy in the histogram as the target color ratio, with reference to the color of the target; and a tracking control unit that controls the pan and/or tilt operation of the camera on the basis of information on the position of the target detected by the first target detection unit when the target color ratio is equal to or lower than a threshold value to cause the camera to track the target, and controls the pan and/or tilt operation of the camera on the basis of information on the position of the target detected by the second target detection unit when the target color ratio exceeds the threshold value to cause the camera to track the target.

According to this aspect, the target color ratio is calculated, and results of the first target detection unit and the second target detection unit are selectively used on the basis of the calculated target color ratio. Accordingly, it is possible to simply detect the position of the target and accurately track the target.

[14] A camera comprises: an imaging unit that captures an optical image of a subject through a lens; a support unit that supports the imaging unit so that the imaging unit can be panned and/or tilted; a target setting unit that sets the target; a hue histogram creation unit that creates a histogram of hue of a range in which the target is tracked; a target color information acquisition unit that acquires information on the color of the target; a first target detection unit that detects a position of the target from the image captured by the imaging unit on the basis of the information on the color of the target; a second target detection unit that detects the position of the target from the image captured by the imaging unit on the basis of information other than the color of the target; a target color ratio calculation unit that calculates a ratio at which pixels with a certain range of hue occupy in the histogram as the target color ratio, with reference to the color of the target; and a tracking control unit that controls the pan and/or tilt operation of the imaging unit on the basis of information on the position of the target detected by the first target detection unit when the target color ratio is equal to or lower than a threshold value to cause the target to be tracked, and controls the pan and/or tilt operation of the imaging unit on the basis of information on the position of the target detected by the second target detection unit when the target color ratio exceeds the threshold value to cause the target to be tracked.

According to this aspect, the target color ratio is calculated, and results of the first target detection unit and the second target detection unit are selectively used on the basis of the calculated target color ratio. Accordingly, it is possible to simply detect the position of the target and accurately track the target.

[15] A camera comprises: an imaging unit that captures an optical image of a subject through a fisheye lens; an image cutout unit that cuts out a portion of an image captured by the imaging unit; a target setting unit that sets the target; a hue histogram creation unit that creates a histogram of hue of a range in which the target is tracked; a target color information acquisition unit that acquires information on the color of the target; a first target detection unit that detects a position of the target from the image captured by the imaging unit on the basis of the information on the color of the target; a second target detection unit that detects the position of the target from the image captured by the imaging unit on the basis of information other than the color of the target; a target color ratio calculation unit that calculates a ratio at which pixels with a certain range of hue occupy in the histogram as the target color ratio, with reference to the color of the target; and a tracking control unit that controls the image cutout unit on the basis of information on the position of the target detected by the first target detection unit when the target color ratio is equal to or lower than a threshold value to cause the target to be tracked, and controls the image cutout unit on the basis of information on the position of the target detected by the second target detection unit when the target color ratio exceeds the threshold value to cause the target to be tracked.

According to this aspect, the target color ratio is calculated, and results of the first target detection unit and the second target detection unit are selectively used on the basis of the calculated target color ratio. Accordingly, it is possible to simply detect the position of the target and accurately track the target.

[16] A terminal device that is communicatably connected to a camera including a pan function and/or a tilting function and controls a pan and/or tilt operation of the camera to cause the camera to execute imaging in which the target is tracked, the terminal device comprising: a target setting unit that sets the target; a hue histogram creation unit that creates a histogram of hue of a range in which the target is tracked; a target color information acquisition unit that acquires information on the color of the target; a first target detection unit that detects a position of the target from the image captured by the camera on the basis of the information on the color of the target; a second target detection unit that detects the position of the target from the image captured by the camera on the basis of information other than the color of the target; a target color ratio calculation unit that calculates a ratio at which pixels with a certain range of hue occupy in the histogram as the target color ratio, with reference to the color of the target; and a tracking control unit that controls the pan and/or tilt operation of the camera on the basis of information on the position of the target detected by the first target detection unit when the target color ratio is equal to or lower than a threshold value to cause the camera to track the target, and controls the pan and/or tilt operation of the camera on the basis of information on the position of the target detected by the second target detection unit when the target color ratio exceeds the threshold value to cause the camera to track the target.

According to this aspect, the target color ratio is calculated, and results of the first target detection unit and the second target detection unit are selectively used on the basis of the calculated target color ratio. Accordingly, it is possible to simply detect the position of the target and accurately track the target.

[17] A tracking imaging method of controlling a pan and/or tilt operation of a camera including a pan function and/or a tilt function to cause the camera to execute imaging in which the target is tracked, the tracking imaging method comprising steps of: setting the target; creating a histogram of hue of a range in which the target is tracked; acquiring information on color of the target; calculating a ratio at which pixels with a certain range of hue occupy in the histogram as the target color ratio, with reference to the color of the target; and detecting a position of the target from the image captured by the camera on the basis of information on the color of the target when the target color ratio is equal to or lower than a threshold value, controlling the pan and/or tilt operation of the camera on the basis of information on the detected position of the target to cause the camera to track the target, and detecting the position of the target from the image captured by the camera on the basis of information other than the color of the target when the target color ratio exceeds the threshold value, and controlling the pan and/or tilt operation of the camera on the basis of information on the detected position of the target to cause the camera to track the target.

According to this aspect, the target color ratio is calculated, and a method of detecting the position of the target is switched on the basis of the calculated target color ratio. Accordingly, it is possible to simply detect the position of the target and accurately track the target.

[18] A tracking imaging program for controlling a pan and/or tilt operation of a camera including a pan function and/or a tilt function to cause the camera to execute imaging in which the target is tracked is recorded, the tracking imaging program causing a computer to realize functions of: setting the target; creating a histogram of hue of a range in which the target is tracked; acquiring information on color of the target; detecting a position of the target from the image captured by the camera on the basis of the information on the color of the target; detecting the position of the target from the image captured by the camera on the basis of information other than the color of the target; calculating a ratio at which pixels with a certain range of hue occupy in the histogram as the target color ratio, with reference to the color of the target; and detecting a position of the target from the image captured by the camera on the basis of information on the color of the target when the target color ratio is equal to or lower than a threshold value, controlling the pan and/or tilt operation of the camera on the basis of information on the detected position of the target to cause the camera to track the target, and detecting the position of the target from the image captured by the camera on the basis of information other than the color of the target when the target color ratio exceeds the threshold value, and controlling the pan and/or tilt operation of the camera on the basis of information on the detected position of the target to cause the camera to track the target, and a computer-readable non-transitory tangible medium having the tracking imaging program recorded thereon.

According to this aspect, the target color ratio is calculated, and a method of detecting the position of the target is switched on the basis of the calculated target color ratio. Accordingly, it is possible to simply detect the position of the target and accurately track the target.

According to the present invention, it is possible to simply detect the target and track the target accurately.

### BRIEF DESCRIPTION OF THE DRAWINGS

FIG. 1 is a system configuration diagram illustrating an embodiment of a tracking imaging system.

FIG. 2 is a block diagram illustrating a system configuration of a camera.

FIG. 3 is a block diagram illustrating a system configuration of a terminal device.

FIG. 4 is a block diagram illustrating a system configuration of a terminal device functioning as a tracking imaging control device.

FIG. 5 is a diagram illustrating a screen display example of a display when a target is set.

FIG. 6 is a diagram illustrating an example of a screen display of a display when a movable range is set.

FIG. 7 is a diagram illustrating an example of image data in a tracking range.

FIG. 8 is a diagram illustrating an example of a histogram of hue.

FIG. 9 is a conceptual diagram of a method of calculating a target color ratio.

FIG. 10 is a flowchart illustrating a procedure of a tracking imaging process in a tracking imaging system

FIG. 11 is a conceptual diagram in a case where a target is tracked by selectively using a first target detection unit and a second target detection unit for each block.

FIG. 12 is a block diagram illustrating a system configuration of a camera that electronically realizes a pan and tilt function.

FIG. 13 is a conceptual diagram of image cutout in an image cutout unit.

FIG. 14 is a diagram illustrating a screen display example of a display of a terminal device.

### DESCRIPTION OF THE PREFERRED EMBODIMENTS

Hereinafter, preferred embodiments for carrying out the present invention will be described in detail with reference to the accompanying drawings.

<<System Configuration>>

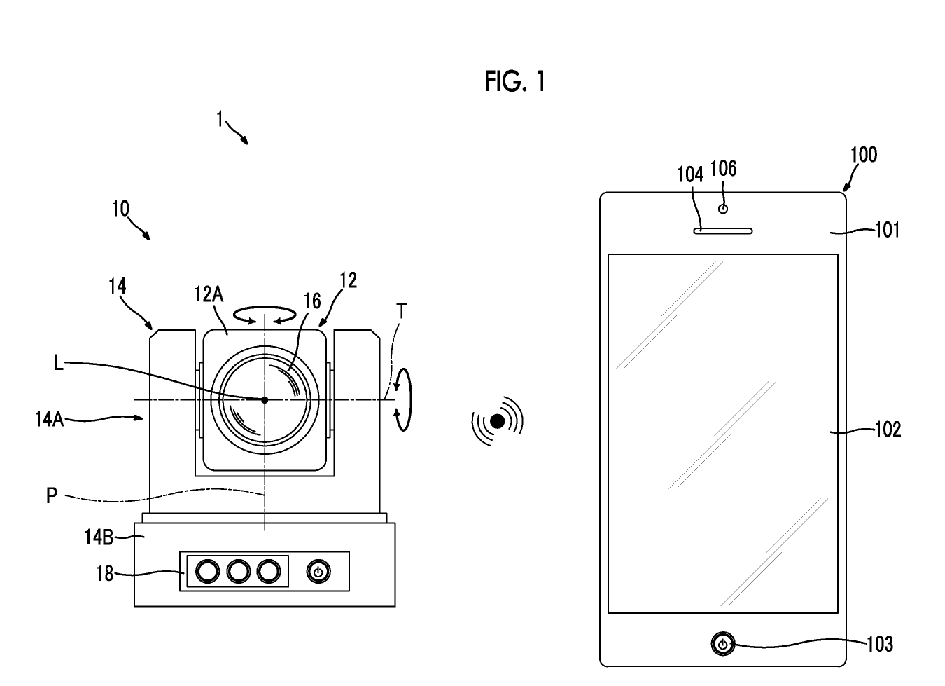

FIG. 1 is a system configuration diagram illustrating an embodiment of a tracking imaging system according to the present invention.

As illustrated in FIG. 1, a tracking imaging system 1 according to this embodiment includes a camera 10 having a pan function and a tilt function, and a terminal device 100 that controls an operation of the camera 10.

<Camera>

As illustrated in FIG. 1, the camera 10 includes an imaging unit 12 that images a subject, and a support unit 14 that supports the imaging unit 12 so that the imaging unit 12 can be panned and tilted.

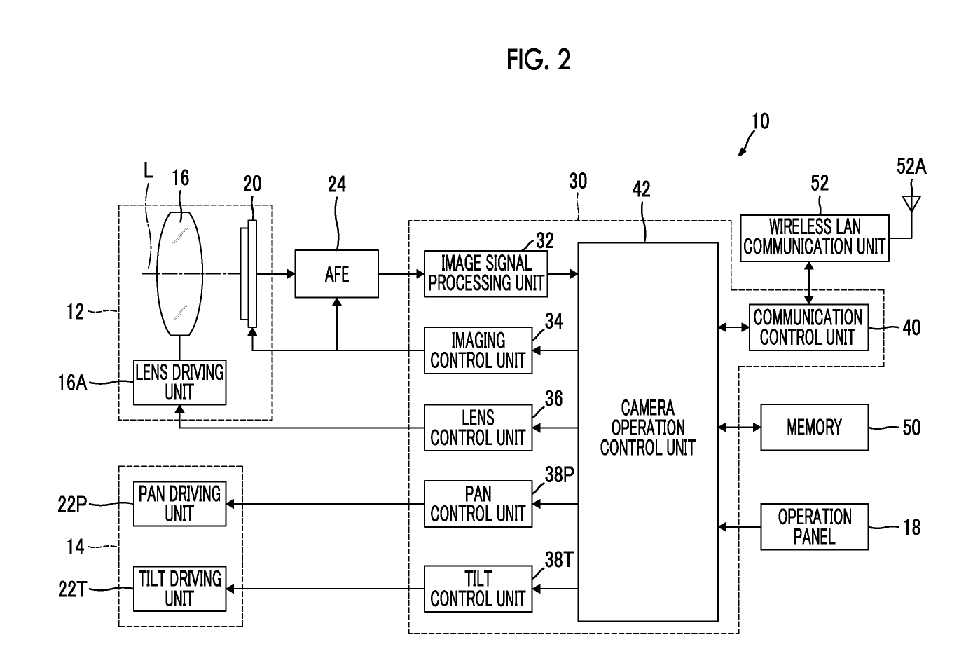

The imaging unit 12 includes a lens 16, and an image sensor 20 (see FIG. 2) that receives light passing through the lens 16. The lens 16 and the image sensor are housed in the housing 12A and formed as a unit.

The lens 16 has a focusing function and a zooming function. A focus of the lens 16 is adjusted by moving a portion of an optical system back and forth along an optical axis L. Further, zoom is adjusted by moving a portion of the optical system back and forth along the optical axis L. The lens 16 is driven by a lens driving unit 16A (see FIG. 2), and focus, zoom, and iris are adjusted.

The image sensor 20 includes a two-dimensional image sensor such as a CCD image sensor (CCD: Charge Coupled Device) or a CMOS image sensor (CMOS: Complementary Metal Oxide Semiconductor).

The support unit 14 includes an imaging unit support frame 14A that rotatably supports the imaging unit 12 around a tilt axis T, and a gantry 14B that rotatably supports the imaging unit support frame 14A around a pan axis P.

The gantry 14B has a substantially rectangular box shape. The gantry 14B has a vertical pan axis P at a center, and rotatably supports the imaging unit support frame 14A around the pan axis P. The gantry 14B has an operation panel 18. Various operation buttons such as a power button are included in the operation panel 18. In the camera 10, various operations are performed through the operation panel 18.

The imaging unit support frame 14A has a substantially U-shape. The imaging unit support frame 14A accommodates the imaging unit 12 in a groove-shaped space, and rotatably supports the imaging unit 12 around the tilt axis T. The tilt axis T is set perpendicular to the pan axis P. In the imaging unit 12 supported by the imaging unit support frame 14A, the optical axis L of the lens 16 is orthogonal to the tilt axis T and the pan axis P.

The imaging unit support frame 14A includes a tilt driving unit 22T (see FIG. 2) that rotates the imaging unit 12 around the tilt axis T. Further, the gantry 14B includes a pan driving unit 22P that rotates the imaging unit support frame 14A around the pan axis P (see FIG. 2). The tilt driving unit 22T includes a tilt motor (not illustrated), and the imaging unit 12 is rotated and tilted about the tilt axis T by driving the tilt motor. The pan driving unit 22P includes a pan motor (not illustrated), and the imaging unit 12 is rotated and panned about the pan axis P by driving the pan motor.

An angle at which the imaging unit 12 can be panned is, for example, 270° (±135°), and an angle at which the imaging unit 12 can be tilted is 135° (−45° to +90°).

FIG. 2 is a block diagram illustrating a system configuration of the camera.

As illustrated in FIG. 2, the camera 10 includes an analog front end (AFE) 24, a camera control unit 30, a memory 50, and a wireless LAN communication unit (LAN: Local Area Network) 52.

The AFE 24 performs, for example, signal processing such as noise removal, signal amplification, or A/D conversion (A/D: Analog/Digital) on the signal (image signal) output from the image sensor 20. A digital image signal generated by the AFE 24 is output to the camera control unit 30.

The camera control unit 30 includes a microcomputer including a central processing unit (CPU) and a memory, and executes a predetermined program to function as an image signal processing unit 32, an imaging control unit 34, a lens control unit 36, a pan control unit 38P, a tilt control unit 38T, a communication control unit 40, and a camera operation control unit 42.

The image signal processing unit 32 performs required signal processing on the digital image signal acquired from the AFE 24, to generate digital image data. For example, the image signal processing unit 32 generates digital image data including image data of a luminance signal (Y) and image data of a color difference signal (Cr, Cb).

The imaging control unit 34 controls driving of the image sensor 20 to control imaging of the image sensor 20.

The lens control unit 36 controls the lens driving unit 16A to control operation of focus, zoom, and an iris of the lens 16.

The pan control unit 38P controls driving of the pan driving unit 22P to control rotation (pan) about the pan axis P of the imaging unit 12.

The tilt control unit 38T controls driving of the tilt driving unit 22T to control rotation (tilt) about the tilt axis T of the imaging unit 12.

The communication control unit 40 controls the wireless LAN communication unit 52 to control wireless LAN communication with an external device. In the tracking imaging system 1 of this embodiment, communication between the terminal device 100 that is an external device is controlled.

The camera operation control unit 42 generally controls an operation of the entire camera according to an instruction from the operation panel 18 and the terminal device 100.

The memory 50 functions as a storage unit for various pieces of data, and data is written and read according to a request from the camera operation control unit 42.

The wireless LAN communication unit 52 performs wireless LAN communication according to a predetermined wireless LAN standard (for example, IEEE802.11a/b/g/n standard [IEEE: The Institute of Electrical and Electronics Engineers, Inc./US Institute of Electrical and Electronics Engineers]) with a wireless LAN access point or an external device capable of wireless LAN communication, via an antenna 52A.

<Terminal Device>

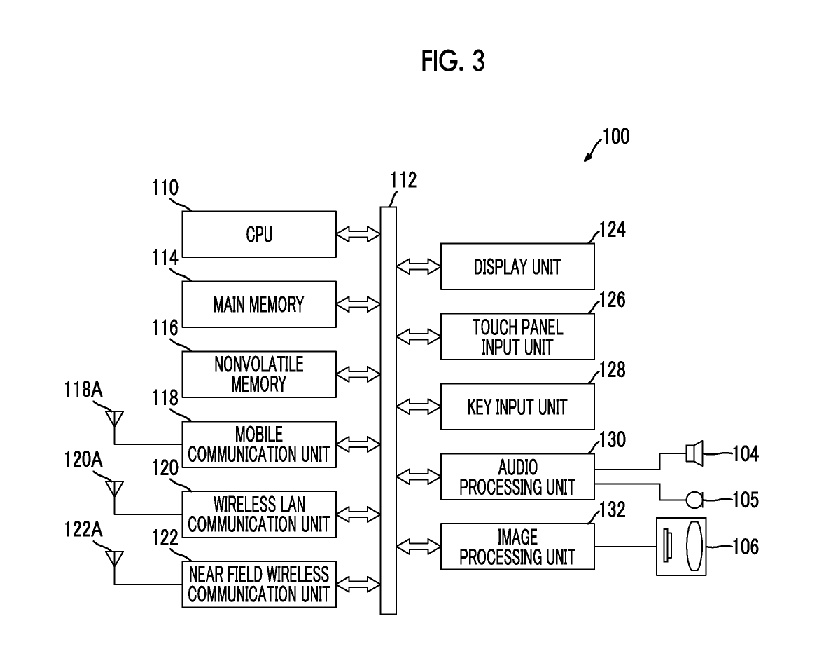

The terminal device 100 includes a so-called smart phone, and includes a display 102, an operation button 103, a speaker 104, a microphone 105 (see FIG. 3), and a built-in camera 106, and the like in a rectangular plate-shaped housing 101, as illustrated in FIG. 1.

FIG. 3 is a block diagram illustrating a system configuration of the terminal device.

As illustrated in FIG. 3, the terminal device 100 includes a CPU 110 that controls an overall operation of the terminal device 100, and has a configuration in which, for example, a main memory 114, a nonvolatile memory 116, a mobile communication unit 118, a wireless LAN communication unit 120, a short-range wireless communication unit 122, a display unit 124, a touch panel input unit 126, a key input unit 128, an audio processing unit 130, and an image processing unit 132 are connected to the CPU 110 via a system bus 112.

The CPU 110 reads an operation program (an operating system (OS) and an application program operating on the OS), fixed form data, and the like stored in the nonvolatile memory 116, loads these to the main memory 114, and executes the operation program, to function as a control unit that controls an overall operation of the terminal device.

The main memory 114 includes, for example, a random access memory (RAM), and functions as a work memory of the CPU 110.

The nonvolatile memory 116 includes, for example, a flash EEPROM (EEPROM: Electrically Erasable Programmable Read Only Memory), and stores the above-described operation program or various fixed form data. Further, the nonvolatile memory 116 functions as a storage unit of the terminal device 100 and stores various pieces of data.

The mobile communication unit 118 executes transmission and reception of data to and from a nearest base station (not illustrated) via an antenna 118A on the basis of a third generation mobile communication system conforming to an IMT-2000 standard (International Mobile Telecommunication-2000) and a fourth generation mobile communication system conforming to an IMT-Advance standard (International Mobile Telecommunications-Advanced).

The wireless LAN communication unit 120 performs wireless LAN communication according to a predetermined wireless LAN communication standard (for example, IEEE802.11a/b/g/n standards) with a wireless LAN access point or an external device capable of wireless LAN communication, via an antenna 120A.

The short-range wireless communication unit 122 executes transmission and reception of data to and from a device conforming to another Bluetooth (registered trademark) standard that is, for example, in a range of (within a radius of about 10 m) of Class 2 via the antenna 122A.

The display unit 124 includes a color liquid crystal panel constituting the display 102, and a driving circuit therefor, and displays various images.

The touch panel input unit 126 is an example of an input unit. The touch panel input unit 126 is integrally formed with the display 102 using a transparent electrode, and generates and outputs two-dimensional position coordinate information corresponding to a touch operation of the user.

The key input unit 128 includes a plurality of key switches including the operation button 103 included in the housing 101 of the terminal device 100, and a driving circuit therefor.

The audio processing unit 130 converts digital audio data provided via the system bus 112 into an analog signal and outputs the analog signal from the speaker 104. Further, the audio processing unit 130 samples the analog sound signal input from the microphone 105 into digital data and outputs the digital data.

The image processing unit 132 converts an analog image signal output from the built-in camera 106 including a lens and an image sensor into a digital image signal, performs required signal processing on the digital image signal, and outputs a resultant image signal.

<Tracking Imaging Control Device>

In the tracking imaging system 1 of this embodiment, the CPU 110 of the terminal device 100 executes a predetermined tracking imaging program, and the terminal device 100 functions as a tracking imaging control device 200.

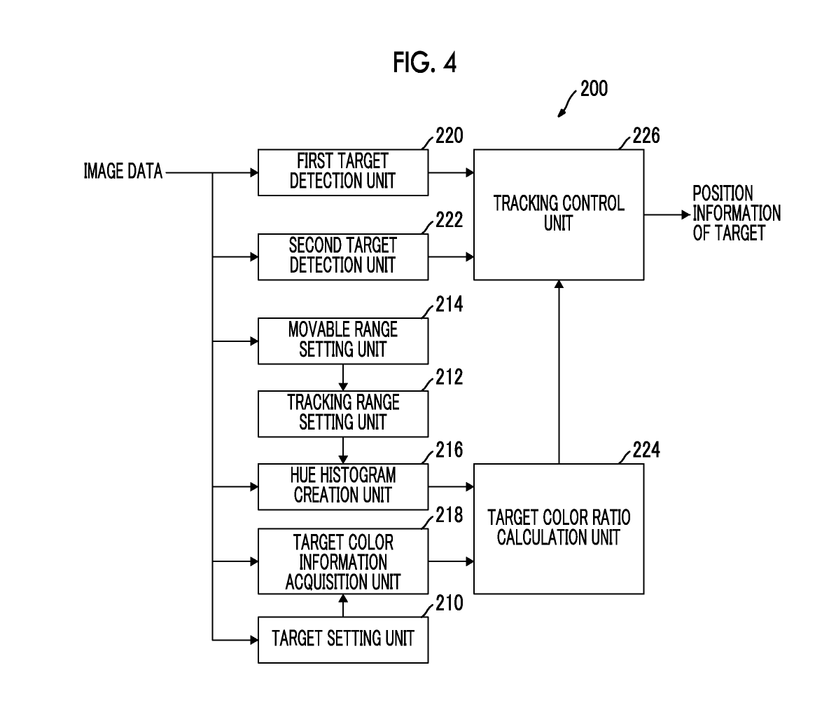

FIG. 4 is a block diagram illustrating a system configuration of a terminal device functioning as a tracking imaging control device.

A tracking imaging control device 200 includes a target setting unit 210, a tracking range setting unit 212, a movable range setting unit 214, a hue histogram creation unit 216, a target color information acquisition unit 218, a first target detection unit 220, a second target detection unit 222, a target color ratio calculation unit 224, and a tracking control unit 226.

The target setting unit 210 sets a target, that is, a subject that is a tracking target. The target setting unit 210 displays an image captured by the camera 10 on the display 102 and sets a subject touched by the user on the screen, as the target.

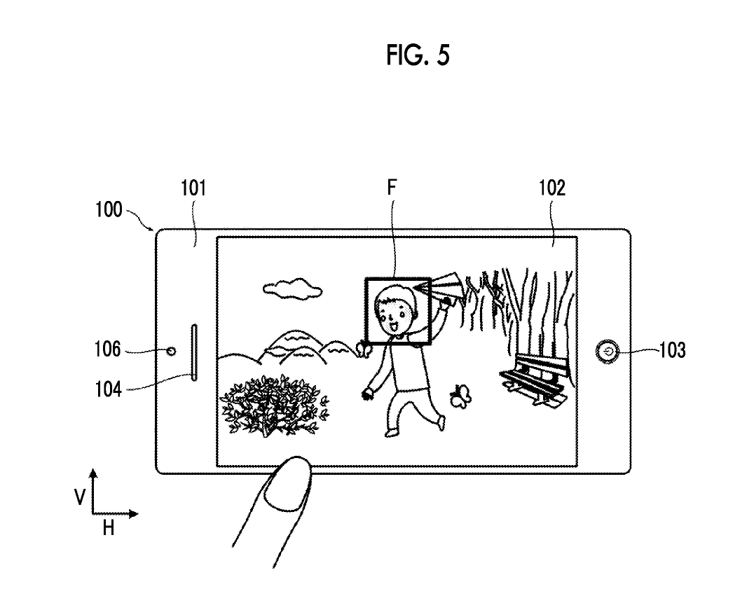

FIG. 5 is a diagram illustrating a screen display example of the display when the target is set.

As illustrated in FIG. 5, when the target is set, the image captured by the camera 10 is displayed on the display 102. The target setting unit 210 acquires image data from the camera 10 and causes the image data to be displayed on the display 102.

The user confirms a screen display of the display 102, and touches a subject that is the tracking target on the screen. The target setting unit 210 sets a rectangular tracking frame F around a touch position on the basis of an output from the touch panel input unit 126. The tracking frame F is superimposed on the image and displayed on the display 102. The subject in the tracking frame F is set as the target.

The tracking range setting unit 212 sets a range in which the target is tracked (tracking range). The tracking range is set as the pan and tilt movable range of the camera 10. Therefore, in a case where the pan and tilt movable range is not limited, the entire pan and tilt movable range is the tracking range.

The movable range setting unit 214 sets the pan and tilt movable range of the camera 10. The movable range setting unit 214 receives a designation of the pan and tilt movable range from the user, and sets the pan and tilt movable range. The pan and tilt movable range is set by determining a moving end in a positive direction of rotation and a moving end in a negative direction of the rotation. This setting is performed by actually panning and tilting the camera 10.

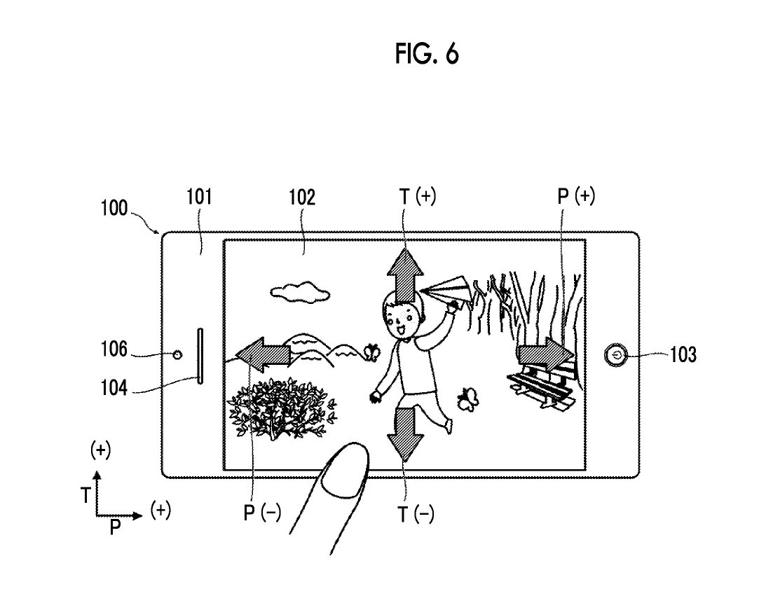

FIG. 6 is a diagram illustrating a screen display example of the display when the movable range is set.

As illustrated in FIG. 6, when the pan and tilt movable range is set, an image being captured is displayed in a live view on the display 102. An arrow P(+) directing panning in a positive direction, an arrow P(−)directing panning in a negative direction, and an arrow T(+) directing tilting in a positive direction, and an arrow T(−)directing tilting in a negative direction are displayed to be superimposed on the image of the live view on the screen of the display 102.

When the arrow P(+) is touched, the camera 10 is instructed to be panned in the positive direction, and when the arrow P(−) is touched, the camera 10 is instructed to be panned in the negative direction. Further, when the arrow T(+) is touched, the camera 10 is instructed to be tilted in the positive direction, and when the arrow T(−) is touched, the camera 10 is instructed to be tilted in the negative direction. The movable range setting unit 214 outputs a pan and tilt instruction to the camera 10 according to the output from the touch panel input unit 126.

The user instructs the camera 10 to panned and tilted while confirming the display of the display 102 and determines a moving end of the rotation in a positive direction of the pan, a moving end of the rotation in a negative direction of the pan, a moving end of the rotation in a positive direction of the tilt, and a moving end of the rotation in a negative direction of the tilt. The movable range setting unit 214 sets the pan and tilt movable range on the basis of the designated moving end of the rotation.

If the pan and tilt movable range is set, the tracking range setting unit 212 sets the set pan and tilt movable range as the tracking range.

The hue histogram creation unit 216 acquires the image data of the tracking range and creates a histogram of the hue of the tracking range.

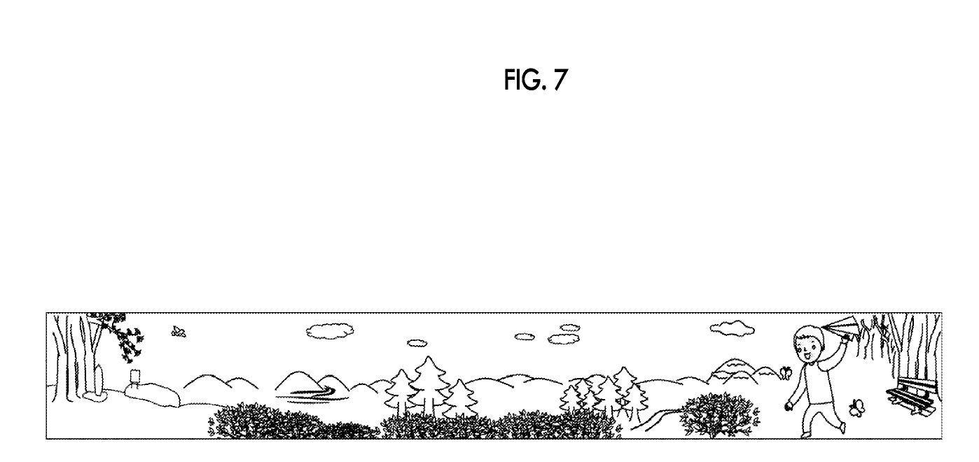

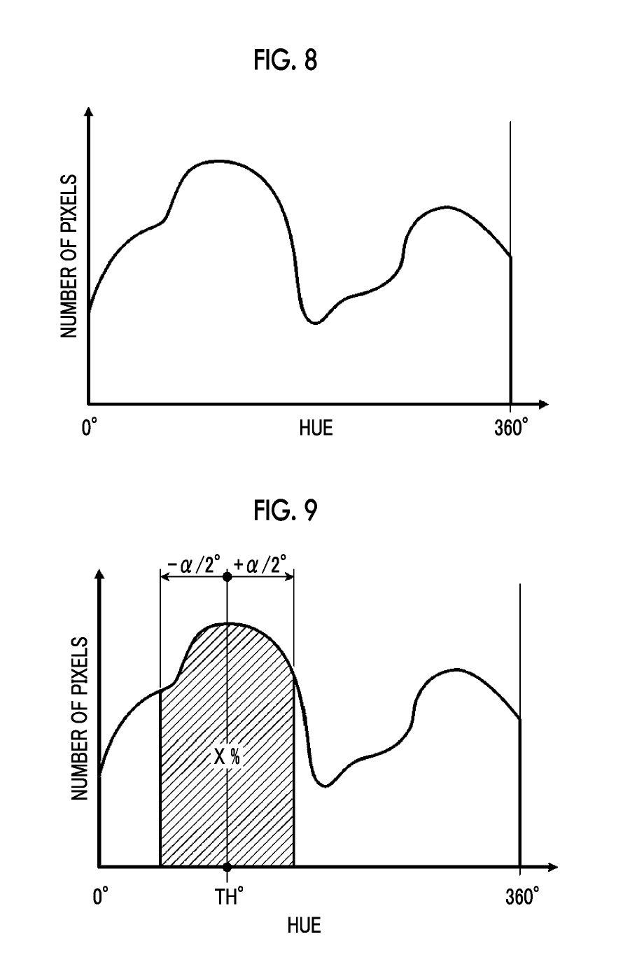

FIG. 7 is a diagram illustrating an example of the image data of the tracking range. FIG. 8 is a diagram illustrating an example of a histogram of the hue.

As illustrated in FIG. 7, the hue histogram creation unit 216 acquires the image data of the entire tracking range, and creates the histogram of the hue. Thus, the hue histogram creation unit 216 causes the camera 10 to be panned and tilted in the movable range, and acquires the image data of the entire tracking range.

The histogram of the hue is represented as a distribution of the number of pixels for each color value using a hue value as a horizontal axis and a hue value as a vertical axis, as illustrated in FIG. 8.

Data of the created histogram of the tracking range is stored in the main memory 114.

The target color information acquisition unit 218 acquires information on the color of the target. The target color information acquisition unit 218 creates the data of the histogram of the hue of the target from the image data when the target is selected, and acquires the information on the color of the target. The data of the histogram of the hue of the target is acquired by creating a histogram of the hue of the image in the tracking frame F. The target color information acquisition unit 218 detects a hue value with the greatest pixel value from the data of the created histogram of the hue of the target and obtains a hue value that is the color of the target. Information on data of the created histogram of the hue of the target, and the hue value of the target is stored in the main memory 114 as the target color information.

The first target detection unit 220 detects the position of the target from the image captured by the camera 10 on the basis of the target color information acquired by the target color information acquisition unit 218. For the detection of the position of the target using the color information, a known technology is used. Hereinafter, a method of detecting the position of the target using the information on the color will be briefly described.

First, image data of one frame is acquired from the camera 10. This image data is first image data. Then, after a predetermined time has elapsed, the image data of one frame is acquired from the camera 10, similar to the first image data. This image is second image data. Then, a difference between the first image data and the second image data is obtained. The obtained image data is difference image data. Then, the difference image data is binarized. Accordingly, ideally, for only the pixels of the moving body, one piece of image data is generated. Then, each subject regarded as being integral is labeled on the basis of the binarized difference image data. Then, an area of the labeled subject is obtained and compared with a threshold value. Then, only the subject larger than the threshold value is selected. Accordingly, the subject smaller than the threshold value or the subject with a small motion is excluded. Then, a first-order moment is obtained for each selected subject, and a centroid position of each selected subject is obtained. This centroid position, for example, is represented by vertical and horizontal coordinate values assumed on the screen. Then, for the pixel range of the selected subject, a histogram of the hue is created from the second image data. One subject closest to the histogram of the hue of the target is selected. The selected subject is recognized as the target, and a centroid position thereof is recognized as the position of the target.

Thus, the first target detection unit 220 detects the position of the target from the image captured by the camera 10 on the basis of the target color information acquired by the target color information acquisition unit 218.

The second target detection unit 222 detects the position of the target from the image captured by the camera 10 on the basis of information other than the target color. In this embodiment, the position of the target is detected using known block matching using template. In the block matching, a motion vector of the target is obtained using a template among a plurality of pieces of image data obtained in time series, to obtain the position of the target. In this case, for example, the position of the target is obtained using the image in the set tracking frame as a template image.

The target color ratio calculation unit 224 calculates a target color ratio X. The target color ratio X is a ratio at which color similar to the target is included in the background. The target color ratio X is calculated as follows.

FIG. 9 is a conceptual diagram of a method of calculating the target color ratio.

The target color ratio X is calculated as a ratio at which the pixels with hue similar to the target occupy in the entirety in the histogram of the hue of the tracking range. A range of the hue similar to the target is set as a certain range (TH±α/2°) if a hue value of the target is TH°. That is, the range of the hue is set from a range of TH−α/2° to TH+α/2°. α is a range in which the hue is recognized as similar hue and is, for example, is 15°. In this case, the range of TH±7.5° is a range of hue similar to the target.

The target color ratio calculation unit 224 calculates a ratio at which the number of pixels in a range in which the hue value is TH±α/2° occurs in the number of pixels of the entire tracking range in the histogram of the hue of the tracking range and calculates the target color ratio X. Therefore, when the target color ratio calculation unit 224 calculates the target color ratio X, the target color ratio calculation unit 224 acquires the histogram data of the hue of the tracking range from the hue histogram creation unit 216 and acquires information on the color value of the target from the target color information acquisition unit 218 to calculate the target color ratio X. The calculated target color ratio X is stored in the main memory 114.

The tracking control unit 226 controls the pan and tilt operations of the camera 10 to cause the camera 10 to track the target on the basis of the position information of the target detected by the first target detection unit 220 and the second target detection unit 222. In this embodiment, the camera 10 is panned and/or tilted so that the target is imaged at a center of the screen. Accordingly, the tracking control unit 226 calculates a rotation angle in the panning direction and a rotation angle in the tilt direction required to cause the target to be located at the center of the screen on the basis of the position information of the target, and outputs the rotation angles to the camera 10.

Incidentally, in the tracking imaging system 1 of this embodiment, the first target detection unit 220 and the second target detection unit 222 are included as means for detecting the position of the target from the image captured by the camera 10. The tracking control unit 226 selectively uses the first target detection unit 220 and the second target detection unit 222 according to the target color ratio X calculated by the target color ratio calculation unit 224. That is, in a case where the target color ratio X calculated by the target color ratio calculation unit 224 is equal to or lower than a threshold value, the first target detection unit 220 is used to detect the target, and in a case where the target color ratio X exceeds the threshold value, the second target detection unit 222 is used to detect the target. The case in which the target color ratio X is equal to or lower than the threshold value is a case where the ratio at which the color similar to the target is included in the background is low. Therefore, in this case, the target is detected using the color information using the first target detection unit 220. On the other hand, the case where the target color ratio X exceeds the threshold value is a case where the ratio at which the color similar to the target is included in the background is high. Therefore, in this case, the target is detected through block matching using the second target detection unit 222. The threshold value is determined according to whether or not the target can be detected using the color information, and an optimal value thereof is determined from a result of a simulation or the like.

The tracking control unit 226 acquires the information on the target color ratio X from the target color ratio calculation unit 224 and compares the target color ratio X with a threshold value. In a case where the target color ratio is equal to or smaller than the threshold value, the tracking control unit 226 controls a pan and/or tilt operation of the camera 10 on the basis of the position information of the target detected by the first target detection unit 220, to cause the camera 10 to track the target. In a case where the target color ratio exceeds the threshold value, the tracking control unit 226 controls the pan and/or tilt operation of the camera 10 on the basis of the position information of the target detected by the second target detection unit 222, to cause the camera 10 to track the target.

<<Tracking Imaging Method>>

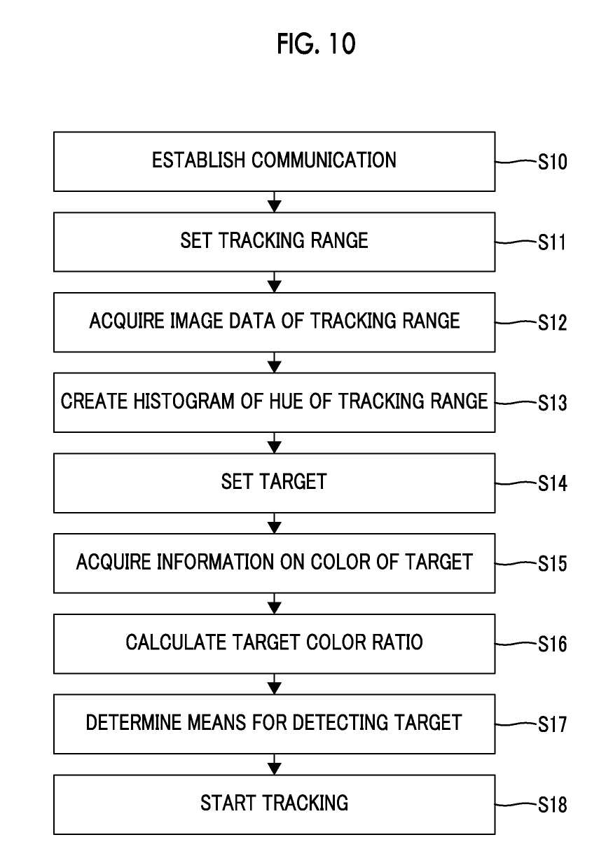

FIG. 10 is a flowchart illustrating a processing procedure of tracking imaging in the tracking imaging system of this embodiment.

Tracking imaging is performed by causing the CPU 110 of the terminal device 100 to execute the tracking imaging program and causing the terminal device 100 to function as the tracking imaging control device 200.

First, the camera 10 and the terminal device 100 are communicatably connected to each other. Therefore, communication between the camera 10 and the terminal device 100 is established (step S10). By communicatably connecting the camera 10 and the terminal device 100 to each other, the control of the camera 10 is enabled on the terminal device 100 side. Further, the image captured by the camera 10 can be displayed on the display 102 of the terminal device 100 or recorded in the nonvolatile memory 116.

Then, setting of the tracking range is performed (step S11). A user can set the pan and tilt movable range of the camera 10 as necessary, to set a tracking range. Information on the set tracking range (pan and tilt movable range) is stored in the main memory 114.

Then, in order to create the histogram of the hue of the tracking range, image data of the tracking range is acquired (step S12). The terminal device 100 causes the camera 10 to be panned and tilted on the basis of the information on the set tracking range, and acquires image data of the entire tracking range from the camera 10.

If the image data of the entire tracking range is acquired, the histogram of the hue of the tracking range is created on the basis of the image data (step S13). Data of the created histogram is stored in the main memory 114.

Then, setting of the target is performed (step S14). When the target is set, an image captured over time by the camera 10 is displayed on the display 102 in real time. The user confirms the image displayed on the display 102, and touches and selects the subject that is a target on the screen. When the target is selected, the image data at the time of target selection is stored in the main memory 114. Further, the tracking frame F is set with reference to the touch position and displayed to overlap the image displayed on the display 102 (see FIG. 5).

Then, the information on the color of the target is acquired (step S15). The terminal device 100 creates a histogram of the hue of the target from the image data at the time of target selection, obtains a hue value of the target from the created histogram, and acquires the information on the color of the target. Data of the created histogram of the hue of the target and the information on the hue value of the target are stored as the target color information in the main memory 114.

Next, the target color ratio X is calculated on the basis of the information on the hue value of the target and the data of the histogram of the hue of the tracking range (step S16). The calculated target color ratio X is stored in the main memory 114.

Then, means for detecting the target is determined on the basis of the calculated target color ratio X (step S17). That is, the target color ratio X is compared with a threshold value, and it is determined whether or not the target color ratio X is equal to or smaller than the threshold value. In a case where the target color ratio X is equal to or smaller than the threshold value, the first target detection unit 220 is selected, and in a case where the target color ratio X exceeds the threshold value, the second target detection unit 222 is selected.

If the means for detecting the target is determined, a position of the target is detected by the determined means, and the tracking process is performed on the basis of information on the detected position (step S18). That is, the position of the target is detected on the basis of the image data that are sequentially acquired from the camera 10, and pan and/or tilt of the camera 10 is controlled so that the target is imaged at a center of the screen.

Thereafter, the user instructs the terminal device 100 to record the image, as necessary, to cause the image captured by the camera 10 to be recorded on the terminal device 100.

Thus, according to the tracking imaging system 1 of this embodiment, a ratio at which color similar to the target is included in the background is calculated, and the target is tracked by selectively using means for detecting the position of the target according to the ratio. Accordingly, it is possible to accurately detect the target and to prevent erroneous tracking. Further, since the histogram of hue of the tracking range is acquired in advance and the means for detecting the position of the target is determined in advance, it is possible to simply detect the position of the target without imposing a load to a process during a tracking operation.

In a case where a tracking range is an entire pan and tilt movable range, it is possible to omit the step of setting the tracking range.

Although the target is set after the tracking range is set in the above processing procedure, the tracking range can be set after the target is set.

### MODIFICATION EXAMPLE

### Modification Example (1) of Tracking Control

Although a configuration in which the first target detection unit 220 and the second target detection unit 222 are selectively used on the basis of the target color ratio X is adopted in the above embodiment, a configuration in which results of the first target detection unit 220 and the second target detection unit 222 are selectively used on the basis of the target color ratio X can be adopted. That is, the position detection process itself is performed in both of the first target detection unit 220 and the second target detection unit 222, and whether or not to use which of the results is determined on the basis of the target color ratio X. In this case, a detection process of the position of the target in the first target detection unit 220 and a detection process of the position of the target in the second target detection unit 222 are performed in parallel.

### Modification Example (2) of Tracking Control

Although the first target detection unit 220 and the second target detection unit 222 are selectively used in relation to the hue of the entire tracking range in the above embodiment, a configuration in which the tracking range is divided into a plurality of blocks and the first target detection unit 220 and the second target detection unit 222 is selectively used for each block can be adopted.

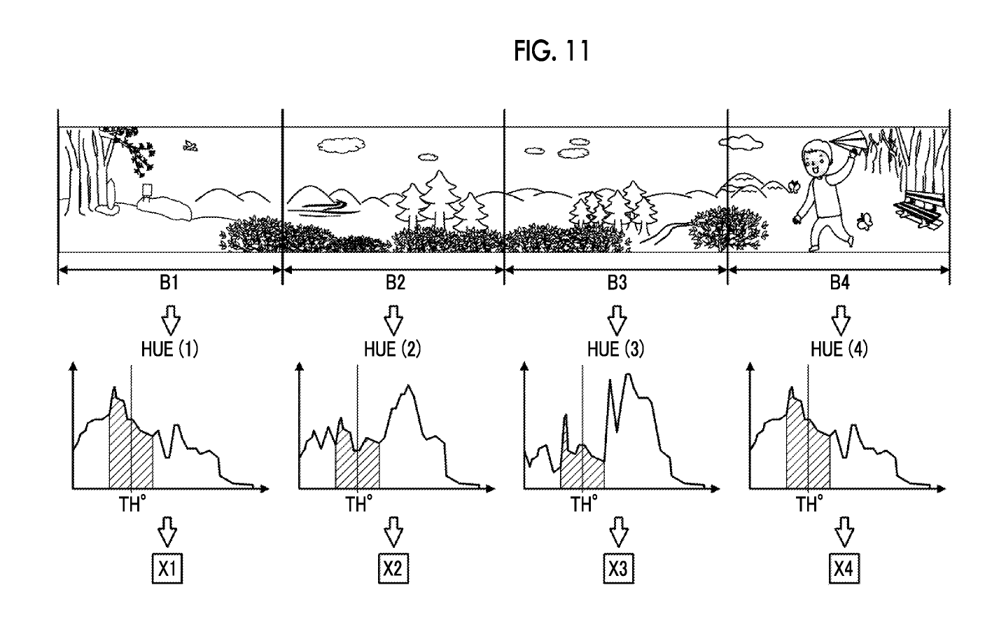

FIG. 11 is a conceptual diagram in a case where a target is tracked by selectively using the first target detection unit and the second target detection unit for each block.

In this case, the hue histogram creation unit 216 divides the tracking range into a plurality of blocks and creates a histogram of hue for each block. In the example illustrated in FIG. 11, an example in which the tracking range is divided into four blocks B1 to B4 is illustrated. In this case, histograms HUE(1) to HUE(4) of the hue of the respective blocks B1 to B4 are created individually.

The target color ratio calculation unit 224 calculates the target color ratios X1 to X4 for the respective blocks B1 to B4.

The tracking control unit 226 sets means for detecting a position of the target for each block. That is, it is assumed that the block of which the target color ratio is equal to or smaller than a threshold value is set using the first target detection unit 220, the block of which the target color ratio exceeds the threshold value is set using the second target detection unit 222. Switching between the first target detection unit 220 and the second target detection unit 222 occurs on the basis of a current position of the target, the position of the target is detected, and the pan and/or tilt operation of the camera 10 is controlled on the basis of a result of the detection to cause the camera 10 to track the target.

The number of blocks in the division can be arbitrarily set by the user or may be automatically set according to a size of the tracking range. Further, the tracking range may be divided only in a pan direction or the number of divisions in the pan direction and a tilt direction may be changed.

### Modification Example (3) of Tracking Control

Although the pan and/or tilt of the camera 10 is controlled so that the target is located at a center of the screen in the above embodiment, the pan and/or tilt of the camera 10 may be controlled so that the target is located at a position on the screen designated by the user.

### Modification Example of Second Target Detection Unit

Although the second target detection unit 222 detects the position of the target using the block matching in the above embodiment, the second target detection unit 222 can detect the position of the target using a feature amount other than the color. For example, a configuration in which the position of the target is detected from the image captured by the camera 10 on the basis of information on luminance or brightness of the target can be adopted. Specifically, the position of the target can be detected using an algorithm for object tracking using a known particle filter, an algorithm for object tracking using a known gradient method, or the like.

### Modification Example (1) of Camera

Although the pan and tilt function is realized by a mechanical configuration in the above embodiment, the pan and tilt function can be realized electronically. That is, a portion of the captured image is cut out to generate image data for output, and the pan and/or tilt function is electronically realized by changing a range for cutting out the image for output.

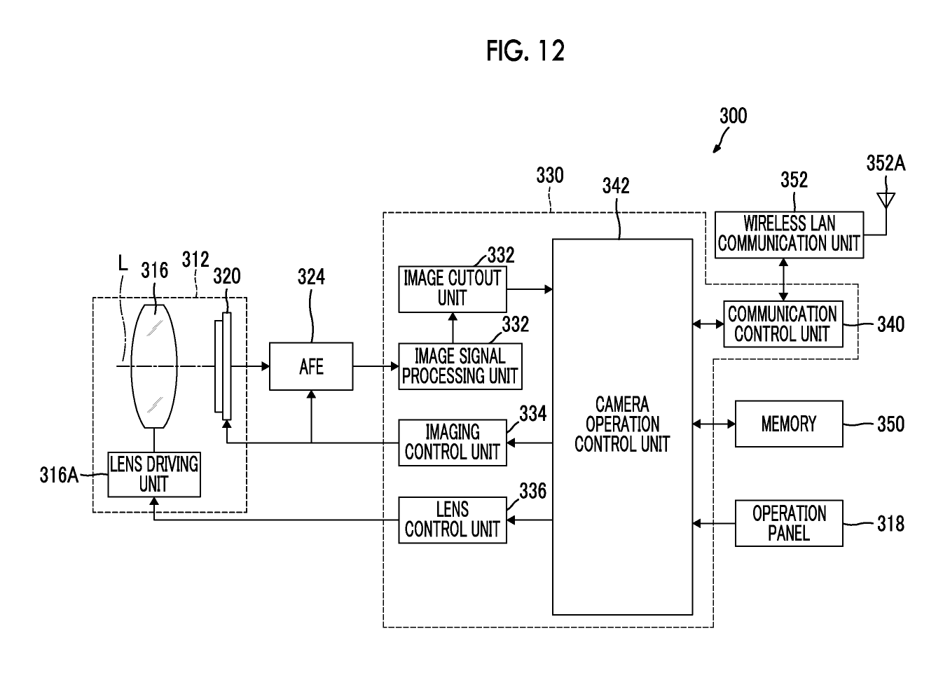

FIG. 12 is a block diagram illustrating a system configuration of a camera that electronically realizes a pan and tilt function.

This camera 300 includes an imaging unit 312 that captures an optical image of a subject through a fisheye lens 316, an AFE 324, a camera control unit 330, a memory 350, and a wireless LAN communication unit 352.

The imaging unit 312 includes a fisheye lens 316, an image sensor 320 that receives light passing through the fisheye lens 316, and a lens driving unit 316A.

The fisheye lens 316 has a focusing function and is driven by the lens driving unit 316A so that a focus and an iris are adjusted. The fisheye lens 316 includes, for example, a diagonal fisheye lens.

The image sensor 320 includes a two-dimensional image sensor such as a CCD image sensor or a CMOS image sensor.

The AFE 324 performs, for example, signal processing such as noise removal, signal amplification, or A/D conversion on a signal (an image signal) output from the image sensor 320. The digital image signal generated by the AFE 324 is output to the camera control unit 330.

The memory 350 functions as a storage unit for various pieces of data, and reading and writing of data is performed according to a request from a camera operation control unit 342.

The wireless LAN communication unit 352 performs wireless LAN communication according to a predetermined wireless LAN standard with a wireless LAN access point or an external device capable of wireless LAN communication, via an antenna 352A.

The camera control unit 330 includes a microcomputer including a CPU and a memory, and functions as an image signal processing unit 332, an imaging control unit 334, a lens control unit 336, a communication control unit 340, a camera operation control unit 342, and an image cutout unit 344 by executing a predetermined program.

The image signal processing unit 332 performs required signal processing on the digital image signals acquired from the AFE 324 to generate digital image data. For example, the image signal processing unit 332 generates digital image data including image data of a luminance signal (Y) and image data of a color difference signal (Cr, Cb).

The imaging control unit 334 controls driving of the image sensor 320 to control imaging of the image sensor 320.

The lens control unit 336 controls the lens driving unit 316A to control focusing of the fisheye lens 316 and an operation of the iris.

The communication control unit 340 controls the wireless LAN communication unit 352 to control the wireless LAN communication with an external device.

The camera operation control unit 342 generally controls the operation of the entire camera according to instructions from the operation unit of the camera 300 and the terminal device (not illustrated).

The image cutout unit 344 acquires the image data generated by the image signal processing unit 332 and cuts out a portion of the image to generate image data for output. The image cutout unit 344 cuts out the image according to the instruction from the camera operation control unit 342, to generate image data for output. For example, an image with an instructed aspect ratio is cut out in an instructed size around an instructed coordinate position to generate image data for output.

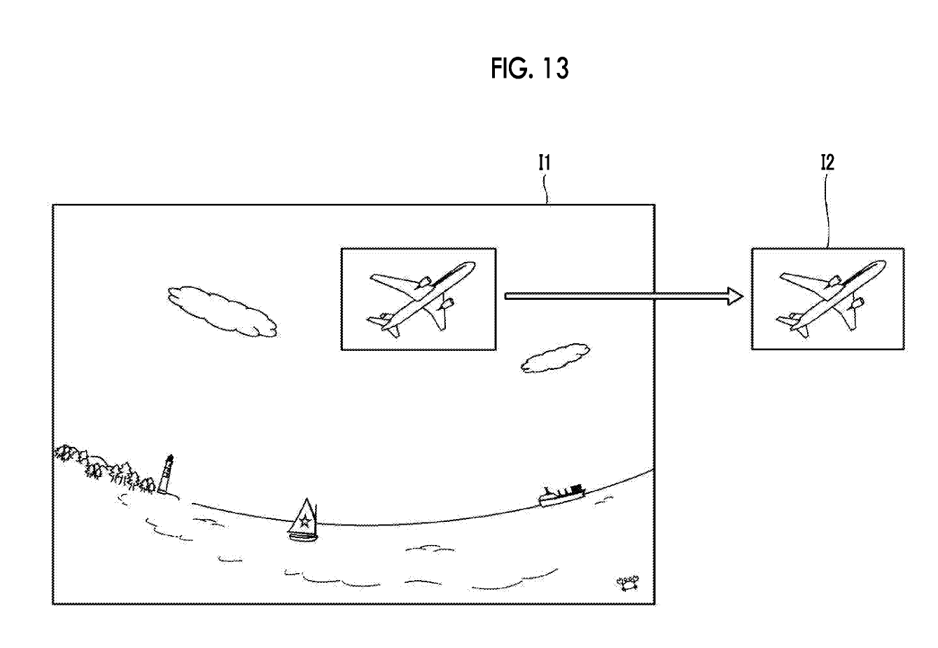

FIG. 13 is a conceptual diagram of cutout of an image in the image cutout unit.

In FIG. 13, an image I1 is an image that is captured by the image sensor 320 via the fisheye lens 316. The image cutout unit 344 cuts out a portion of the image I1 and generates an image I2 for output.

The camera 300 outputs the image I2 cut out by the image cutout unit 344 as an image for output to the terminal device 100.

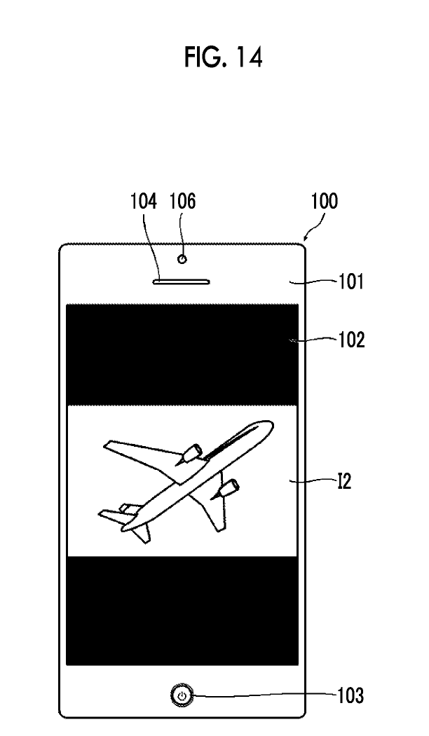

FIG. 14 is a diagram illustrating a screen display example of a display of the terminal device.

As illustrated in FIG. 14, an image I2 cut out from the image I1 captured through the fisheye lens 316 is displayed as the image captured by the camera 300 in the display 102 of the terminal device 100.

Thus, the camera 300 that electronically realizes a pan and tilt function is configured to cut out a portion of an actually imaged image and output image data and configured to be panned and/or tilted by changing a cutout position.

Although the configuration in which a portion of the image captured by the single imaging unit is cut out and the image data for output is acquired is adapted in the above example, a configuration in which a plurality of imaging units are included in the camera, images captured by the plurality of imaging units are combined to generate a single image, a portion of the image is cut out, and image data for output is acquired can be adopted. For example, a configuration in which a first imaging unit that images the front and a second imaging unit that images the rear are included, an image captured by the first imaging unit and an image captured by the second imaging unit are combined to generate one image, a camera capable of imaging 360° in a pan direction is formed, a portion of the image is cut out, and image data for output is acquired can be adopted.

### Modification Example (2) of Camera

Although the camera 10 of the above embodiment includes the function of the pan and tilt function, the camera may include at least the pan or tilt function. In the case of a camera including only a pan function, tracking of the target is performed only in a pan operation. Similarly, in the case of a camera including only a tilt function, tracking of the target is performed only in a tilt operation.

### Modification Example of Target Setting Unit

In the above-described embodiment, the image captured by the camera 10 is displayed on the display 102 and a subject on the screen touched by the user is set as the target, but a method of setting the target is not limited thereto.

For example, a configuration in which a function of automatically detecting a face of a person from the image captured by the camera (a function of the face detection unit) is added as a function of the tracking imaging control device, and the face of the person detected using the function is automatically set as the target can be adopted. Accordingly, it is possible to simply set the target.

In this case, the plurality of faces may be detected, but in this case, for example, a configuration in which a result of the detection is displayed to the user and a subject is selected as the target can be adopted. Further, a configuration in which the target can be automatically determined from a size or a position of the detected face can be adopted. For example, a main subject is determined under a determination criterion that a face located at a center of the screen seems to be the main subject and a larger face seems to be the main subject, and the target is automatically o determined.

Further, for example, a configuration in which a function of detecting a moving body from the image captured by the camera (a function of a moving body detection unit) is added as a function of the tracking imaging control device, and a moving body first detected using the function is set as the target can be adopted. Accordingly, it is possible to simply set the target.

In this case, a plurality of moving bodies may be detected at the same time, but in this case, a configuration in which a user is caused to select the subject that is a target can be adopted. Alternatively, a configuration in which the target is automatically determined from a size or a position of the detected moving body can be adopted.

Further, although the tracking frame having a predetermined size is set on the basis of touch position information in the above embodiment, the position and the size of the tracking frame may be adjusted by the user.

Further, a position and a size of the tracking frame may be automatically adjusted. For example, a moving body may be extracted with reference to the touch position and the tracking frame may be set to surround the moving body. Alternatively, a face of a person may be extracted with reference to a touch position and the tracking frame may be set to surround the face.

Further, although the image captured by the camera is displayed on the display of the terminal device in real time and the target is selected in the above embodiment, a configuration in which a still image is captured and displayed on the display and the target is selected can be adopted.

Further, a configuration in which the image of the target is registered in advance and read to set the target can be adopted.

### Modification Example of Calculation of Target Color Ratio

In the above embodiment, when the hue value of the target is TH°, a range of TH±α/2° is used as a range of hues similar to the target, and the target color ratio is calculated. An example of α is 15°. α set as the range of the hue similar to the target may be a fixed value or may be set arbitrarily. Further, a configuration in which the value of α is automatically set according to the ratio of color similar to the target included in the tracking range may be adopted. For example, the histogram of the tracking range is analyzed, and when a ratio of the hue similar to the target is higher, the value of α is set to a small value. That is, when a larger number of colors similar to the target are included in the tracking range that is a background, the value of α is set to a small value.

If the α is changed in this way, the target color ratio X is changed and a frequency at which the position of the target is detected using the color information is changed. Therefore, in a case where α is changed, the threshold value is changed in conjunction with the change in α so that the frequency at which the position of the target is detected using the color information is changed. That is, in a case where α decreases, the threshold value decreases in conjunction with this, and in a case where α increases, the threshold value increases in conjunction with this. Accordingly, the position detection of the target using the color information and the position detection of the target using information other than the color can be selectively used.

### Modification Example of Method of Setting Tracking Range

In the above embodiment, the pan and tilt movable range is set as the tracking range, a method of setting the tracking range is not limited thereto. For example, the range in which the user performs imaging can be set as the tracking range using the pan and tilt function of the camera 10. In this case, as a pre-setting operation, the user performs imaging in a range that is the tracking range using the pan and tilt function of the camera 10. Thus, in a case where the range in which the user performs imaging is a tracking range, an image of an entire tracking range required for creation of the hue histogram can be simultaneously acquired.

In a case where the pan and tilt movable range is set, a range in which the user has performed imaging can be used as the pan and tilt movable range.

<Camera Including Tracking Imaging Function>

Although the configuration in which the terminal device functions as the tracking imaging control device, and the terminal device detects the position of the target and controls the pan and tilt of the camera is adopted in the above embodiment, a configuration in which the camera is equipped with the function of the tracking imaging control device, and the camera detects the position of the target and controls the pan and tilt of the camera can be adopted. In this case, the camera is equipped with the functions of the target setting unit, the hue histogram creation unit, the first target detection unit, the second target detection unit, the target color ratio calculation unit, and the tracking control unit. These functions can be provided as functions of the camera control unit. That is, the microcomputer constituting the camera control unit can cause the camera control unit to function as the target setting unit, the hue histogram creation unit, the first target detection unit, the second target detection unit, the target color ratio calculation unit, and the tracking control unit by executing a predetermined tracking imaging program.

Thus, in a case where the camera is equipped with the function of the tracking imaging control device, the terminal device can be configured to perform only a display of the image captured by the camera or only the display and recording of the image. Alternatively, the terminal device can be configured to perform only setting of the target.

Further, in the case where the camera is equipped with the function of the tracking imaging control device in this way, the camera can be operated alone to perform the tracking imaging. In this case, it is preferable for the camera to include a display unit and a touch panel input unit.

<Connection Form Between Camera and Terminal Device>

Although the camera and the terminal device are connected wirelessly communicatably in the above embodiment, the camera and the terminal device may be connected mutually communicatably. Therefore, the camera and the terminal device may be connected communicatably in a wired manner. Further, a communication standard or the like is not particularly limited. Further, the camera and the terminal device are not directly connected and, for example, the camera and the terminal device may be connected over the Internet.

<Terminal Device>

In the above embodiment, the smart phone is adopted as the terminal device, but the form of the terminal device is not particularly limited. Therefore, the terminal device can include a personal computer or a tablet computer. Further, the terminal device can include a dedicated device.

<Display of Histogram of Hue of Tracking Range>

Although the data of the created histogram of the hue of the tracking range is used only for calculation of the target color ratio in the above embodiment, the histogram of the hue of the tracking range may be created and then the data thereof may be displayed on the display unit. Accordingly, the user can use the data as a judgment material when setting the target. The data of the histogram, for example, can be displayed over the screen at the time of setting of the target.

<Presentation of Detectable Color>

By acquiring the data of the histogram of the hue of the tracking range, it is possible to obtain the color from which the position of the target can be detected using the color information in advance. That is, by acquiring the data of the histogram of the hue of the tracking range, it is possible to obtain the hue value at which the target color ratio is equal to or lower than the threshold value from the data. Accordingly, by acquiring the data of the histogram of the hue of the tracking range, the color from which the position of the target can be detected using the color information can be obtained in advance. Thus, color from which the position of the target can be detected may be obtained from the data of the histogram of the hue of the tracking range in advance, and information on the obtained color may be presented to the user at the time of setting of the target. For example, the information on the color (hue) from which the position of the target can be detected using the color information can be displayed to be superimposed on the screen at the time of setting of the target. Accordingly, the user can use the information as a judgment material when setting the target

### EXPLANATION OF REFERENCES

1: tracking imaging system
10: camera
12: imaging unit
12A: housing
14: support unit
14A: imaging unit support frame
14B: gantry
16: lens
16A: lens driving unit
18: operation panel
20: image sensor
22P: pan driving unit
22T: tilt driving unit
30: camera control unit
32: image signal processing unit
34: imaging control unit
36: lens control unit
38P: pan control unit
38T: tilt control unit
40: communication control unit
42: camera operation control unit
50: memory
52: wireless LAN communication unit
52A: antenna
100: terminal device
101: housing
102: display
103: operation button
104: speaker
105: microphone
106: built-in camera
110: CPU
112: system bus
114: main memory
116: nonvolatile memory
118: mobile communication unit
118A: antenna
120: wireless LAN communication unit
120A: antenna
122: near field wireless communication unit
122A: antenna
124: display unit
126: touch panel input unit
128: key input unit
130: audio processing unit
132: image processing unit
200: tracking imaging control device
210: target setting unit
212: tracking range setting unit
214: movable range setting unit
216: hue histogram creation unit
218: target color information acquisition unit
220: first target detection unit
222: second target detection unit
224: target color ratio calculation unit
226: tracking control unit
300: camera
312: imaging unit
316: fisheye lens
316A: lens driving unit
320: image sensor
330: camera control unit
332: Image signal processing unit
334: imaging control unit
336: lens control unit
340: communication control unit
342: camera operation control unit
344: image cutout unit
350: memory
352: wireless LAN communication unit
352A: antenna
F: range of tracking frame

What is claimed is:

1. A tracking imaging control device that controls a pan and/or tilt operation of a camera including a pan function and/or a tilt function to cause the camera to execute imaging in which the target is tracked, the tracking imaging control device comprising:
a target setting unit that sets the target;
a hue histogram creation unit that creates a histogram of hue of a range in which the target is tracked;
a target color information acquisition unit that acquires information on the color of the target;
a first target detection unit that detects a position of the target from the image captured by the camera on the basis of the information on the color of the target;
a second target detection unit that detects the position of the target from the image captured by the camera on the basis of information other than the color of the target;
a target color ratio calculation unit that calculates a ratio at which pixels with a certain range of hue occupy in the histogram as the target color ratio, with reference to the color of the target; and
a tracking control unit that controls the pan and/or tilt operation of the camera on the basis of information on the position of the target detected by the first target detection unit when the target color ratio is equal to or lower than a threshold value to cause the camera to track the target, and controls the pan and/or tilt operation of the camera on the basis of information on the position of the target detected by the second target detection unit when the target color ratio exceeds the threshold value to cause the camera to track the target.

2. The tracking imaging control device according to claim 1,
wherein the second target detection unit detects the position of the target from the image captured by the camera on the basis of information on luminance or brightness of the target.

3. The tracking imaging control device according to claim 1,
wherein the camera includes
an imaging unit that captures an optical image of a subject through a lens, and
a support unit that supports the imaging unit so that the imaging unit can be panned and/or tilted.

4. The tracking imaging control device according to claim 1,
wherein the camera includes
an imaging unit that captures an optical image of a subject through a fisheye lens; and
an image cutout unit that cuts out a portion of the image captured by the imaging unit,
wherein the pan and/or tilt function is realized by changing a position at which the image cutout unit cuts out an image.

5. The tracking imaging control device according to claim 1, further comprising:
a tracking range setting unit that sets a range in which the target is tracked, as the tracking range.

6. The tracking imaging control device according to claim 5,
wherein the tracking range setting unit sets the pan and/or tilt movable range of the camera as the tracking range.

7. The tracking imaging control device according to claim 6, further comprising:
a movable range setting unit that sets a pan and/or tilt movable range of the camera.

8. The tracking imaging control device according to claim 1,
wherein the hue histogram creation unit creates the histogram of the hue of the range in which the target is tracked, on the basis of image data obtained by imaging an entire range in which the target is tracked using the camera.

9. The tracking imaging control device according to claim 1, further comprising:
a display unit that displays the image captured by the camera; and
an input unit that designates a position on the screen of the display unit,
wherein the target setting unit sets a subject at the position designated by the input unit as the target.

10. The tracking imaging control device according to claim 1, further comprising:
a face detection unit that detects a face of a person from the image captured by the camera,
wherein the target setting unit sets the face of the person detected by the face detection unit as the target.

11. The tracking imaging control device according to claim 1, further comprising:
a moving body detection unit that detects a moving body from the image captured by the camera,
wherein the target setting unit sets the moving body first detected by the moving body detection unit as the target.

12. The tracking imaging control device according to claim 1,
wherein the hue histogram creation unit divides the range in which the target is tracked into a plurality of blocks, and creates the histogram of the hue for each of the blocks,
the target color ratio calculation unit calculates a target color ratio for each block, the target color ratio being a ratio at which pixels with a certain range of hue occupy in the histogram with reference to the color of the target, and
the tracking control unit controls the pan and/or tilt operation of the camera on the basis of the information on the position of the target detected by the first target detection unit for the block in which the target color ratio is equal to or lower than a threshold value to cause the camera to track the target, and controls the pan and/or tilt operation of the camera on the basis of the information on the position of the target detected by the second target detection unit for the block in which the target color ratio exceeds the threshold value to cause the camera to track the target.

13. A tracking imaging system that includes a camera including a pan function and/or a tilting function, and a terminal device that is communicatably connected to the camera and controls a pan and/or tilt operation of the camera to cause the camera to execute imaging in which the target is tracked, the terminal device comprising:
a target setting unit that sets the target;
a hue histogram creation unit that creates a histogram of hue of a range in which the target is tracked;
a target color information acquisition unit that acquires information on the color of the target;
a first target detection unit that detects a position of the target from the image captured by the camera on the basis of the information on the color of the target;
a second target detection unit that detects the position of the target from the image captured by the camera on the basis of information other than the color of the target;
a target color ratio calculation unit that calculates a ratio at which pixels with a certain range of hue occupy in the histogram as the target color ratio, with reference to the color of the target; and
a tracking control unit that controls the pan and/or tilt operation of the camera on the basis of information on the position of the target detected by the first target detection unit when the target color ratio is equal to or lower than a threshold value to cause the camera to track the target, and controls the pan and/or tilt operation of the camera on the basis of information on the position of the target detected by the second target detection unit when the target color ratio exceeds the threshold value to cause the camera to track the target.

14. A camera, comprising:
an imaging unit that captures an optical image of a subject through a lens;
a support unit that supports the imaging unit so that the imaging unit can be panned and/or tilted;
a target setting unit that sets the target;
a hue histogram creation unit that creates a histogram of hue of a range in which the target is tracked;
a target color information acquisition unit that acquires information on the color of the target;
a first target detection unit that detects a position of the target from the image captured by the imaging unit on the basis of the information on the color of the target;
a second target detection unit that detects the position of the target from the image captured by the imaging unit on the basis of information other than the color of the target;
a target color ratio calculation unit that calculates a ratio at which pixels with a certain range of hue occupy in the histogram as the target color ratio, with reference to the color of the target; and
a tracking control unit that controls the pan and/or tilt operation of the imaging unit on the basis of information on the position of the target detected by the first target detection unit when the target color ratio is equal to or lower than a threshold value to cause the target to be tracked, and controls the pan and/or tilt operation of the imaging unit on the basis of information on the position of the target detected by the second target detection unit when the target color ratio exceeds the threshold value to cause the target to be tracked.

15. A camera, comprising:
an imaging unit that captures an optical image of a subject through a fisheye lens;
an image cutout unit that cuts out a portion of an image captured by the imaging unit;
a target setting unit that sets the target;
a hue histogram creation unit that creates a histogram of hue of a range in which the target is tracked;
a target color information acquisition unit that acquires information on the color of the target;
a first target detection unit that detects a position of the target from the image captured by the imaging unit on the basis of the information on the color of the target;
a second target detection unit that detects the position of the target from the image captured by the imaging unit on the basis of information other than the color of the target;
a target color ratio calculation unit that calculates a ratio at which pixels with a certain range of hue occupy in the histogram as the target color ratio, with reference to the color of the target; and
a tracking control unit that controls the image cutout unit on the basis of information on the position of the target detected by the first target detection unit when the target color ratio is equal to or lower than a threshold value to cause the target to be tracked, and controls the image cutout unit on the basis of information on the position of the target detected by the second target detection unit when the target color ratio exceeds the threshold value to cause the target to be tracked.

16. A terminal device that is communicatably connected to a camera including a pan function and/or a tilting function and controls a pan and/or tilt operation of the camera to cause the camera to execute imaging in which the target is tracked, the terminal device comprising:
a target setting unit that sets the target;
a hue histogram creation unit that creates a histogram of hue of a range in which the target is tracked;
a target color information acquisition unit that acquires information on the color of the target;
a first target detection unit that detects a position of the target from the image captured by the camera on the basis of the information on the color of the target;
a second target detection unit that detects the position of the target from the image captured by the camera on the basis of information other than the color of the target;
a target color ratio calculation unit that calculates a ratio at which pixels with a certain range of hue occupy in the histogram as the target color ratio, with reference to the color of the target; and
a tracking control unit that controls the pan and/or tilt operation of the camera on the basis of information on the position of the target detected by the first target detection unit when the target color ratio is equal to or lower than a threshold value to cause the camera to track the target, and controls the pan and/or tilt operation of the camera on the basis of information on the position of the target detected by the second target detection unit when the target color ratio exceeds the threshold value to cause the camera to track the target.

17. A tracking imaging method of controlling a pan and/or tilt operation of a camera including a pan function and/or a tilt function to cause the camera to execute imaging in which the target is tracked, the tracking imaging method comprising steps of:
setting the target;
creating a histogram of hue of a range in which the target is tracked;
acquiring information on color of the target;
calculating a ratio at which pixels with a certain range of hue occupy in the histogram as the target color ratio, with reference to the color of the target; and
detecting a position of the target from the image captured by the camera on the basis of information on the color of the target when the target color ratio is equal to or lower than a threshold value, controlling the pan and/or tilt operation of the camera on the basis of information on the detected position of the target to cause the camera to track the target, and detecting the position of the target from the image captured by the camera on the basis of information other than the color of the target when the target color ratio exceeds the threshold value, and controlling the pan and/or tilt operation of the camera on the basis of information on the detected position of the target to cause the camera to track the target.

18. A computer-readable non-transitory tangible medium on which a tracking imaging program for controlling a pan and/or tilt operation of a camera including a pan function and/or a tilt function to cause the camera to execute imaging in which the target is tracked is recorded, the tracking imaging program causing a computer to realize functions of:
setting the target;
creating a histogram of hue of a range in which the target is tracked;
acquiring information on color of the target;
detecting a position of the target from the image captured by the camera on the basis of the information on the color of the target;
detecting the position of the target from the image captured by the camera on the basis of information other than the color of the target;
calculating a ratio at which pixels with a certain range of hue occupy in the histogram as the target color ratio, with reference to the color of the target; and
detecting a position of the target from the image captured by the camera on the basis of information on the color of the target when the target color ratio is equal to or lower than a threshold value, controlling the pan and/or tilt operation of the camera on the basis of information on the detected position of the target to cause the camera to track the target, and detecting the position of the target from the image captured by the camera on the basis of information other than the color of the target when the target color ratio exceeds the threshold value, and controlling the pan and/or tilt operation of the camera on the basis of information on the detected position of the target to cause the camera to track the target.
